(19) United States
(12) Patent Application Publication
(10) Pub. No.: US 2004/0015616 A1
(43) Pub. Date: Jan. 22, 2004

(54) Multiple ports ethernet switch chip and daisy chain test for multiple ports ethernet switch chip

(76) Inventor: Aphrodite Chen, Hsinchu (TW)

Correspondence Address: RABIN & BERDO, P.C., 1101 14th Street, N.W., Washington, DC, 20005, US

(21) Appl. No.: 10/619,144

(22) Filed: Jul. 15, 2003

(30) Foreign Application Priority Data
Jul. 18, 2002 (TW) 091116094

(51) Int. Cl. G06F 3/00

(52) U.S. Cl. 710/1

(57) ABSTRACT

A single chip Ethernet switch integrated with physical layer entity is switched between a normal mode and a daisy chain test mode by a mode select signal. Under the daisy chain test mode, each port of the switch is connected to a passive loop-back device, other than a start transmission port and a stop receiving port. A test packet is supplied to the start transmission port and transmitted eventually from the start transmission port to the stop receiving port through each port of the switch with initialization of an address table and a packet source address learning process.

### FIELD OF THE INVENTION

The present invention relates generally to an Ethernet switch chip and its test method, and more particularly to a three-in-one Ethernet switch chip and daisy chain test for the chip.

### BACKGROUND OF THE INVENTION

It is a trend to integrate Ethernet switch controller, memory and Ethernet physical layer entity (PHY) into one chip. However, the Ethernet PHY is an analog integrated circuit and the other two are digital circuits. The test for a three-in-one Ethernet switch chip therefore becomes complicated and expensive. Conventional test method is to test the analog integrated circuit and the digital circuit, respectively. Consequently, the test time is prolonged and it costs much more for the analog tester is expensive. The conventional test method for the integrated Ethernet switch chip is almost the same as that for individual analog and digital tests in the past and, therefore, can hardly be greatly improved.

Thus, an Ethernet switch chip that can simplify the test is proposed herewith, and new and more efficient test for the chip is disclosed hereinafter.

### SUMMARY OF THE INVENTION

One object of the present invention is to provide an Ethernet switch chip that integrates PHY comprises a daisy chain test mode switched by a mode select signal to the daisy chain test mode. Under the daisy chain test mode, several ports of the chip are connected to a passive loop-back device, respectively, and a start transmission port (STP) and a stop receiving port (SRP) are selected. An address resolution control logic in the chip operates a source address (SA) learning engine equipped with the function of the daisy chain test for an inputted or internally generated test packet to be eventually delivered from the STP to the SRP so as to test the chip. In an embodiment, the chip comprises a register for storage of the information to internally generate the test packet.

Another object of the present invention is to provide a daisy chain test for the Ethernet switch chip, comprises an initially writing to an address table and a packet SA learning process to guide the test packet from the STP to the SRP under the operation of the source address learning engine with the function of daisy chain test, and determining the test result by verifying the last received packet at the SRP. The test packet is either inputted from outside of the chip or generated from inside of the chip. Should it be the later, the test further comprises access the information from the register to generate the test packet.

By use of the present invention, the cost and test time for the chip will be greatly reduced for the chip manufacturers, and moreover, only a digital tester is required for the test of the chip.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a simplified functional block diagram to illustrate an Ethernet switch chip according to the present invention;

FIG. 2 is a simplified functional block diagram to illustrate another Ethernet switch chip according to the present invention;

FIG. 3 illustrates the internal circuit of the Ethernet switch chip according to the present invention;

FIG. 4 illustrates an information format of the address table in the Ethernet switch chip;

FIG. 5 shows the searched result of the destination address (DA) of the address resolution control logic of the Ethernet switch;

FIG. 6 shows an initialized address table before a conventional learning process;

FIG. 7 illustrates an arrangement of a conventional learning process;

FIG. 8 shows an address table of the learned result in FIG. 7;

FIG. 9 shows the arrangement for the learning process by replacing the test equipments in FIG. 7 with passive loop-back devices;

FIG. 10 illustrates an address table of the learned result in FIG. 9;

FIG. 11 shows an initialized address table for a daisy chain test according to the present invention;

FIG. 12 shows the arrangement for the learning process according to the present invention;

FIG. 13 shows an address table of the learned result at a port in FIG. 12;

FIG. 14 shows an address table of the learned result at another port in FIG. 12;

FIG. 15 shows an address table of the learned result at the last port before the SRP in FIG. 12; and

FIG. 16 illustrates the arrangement for the learning process under a broadcast test according to the present invention.

### DETAILED DESCRIPTION OF THE INVENTION

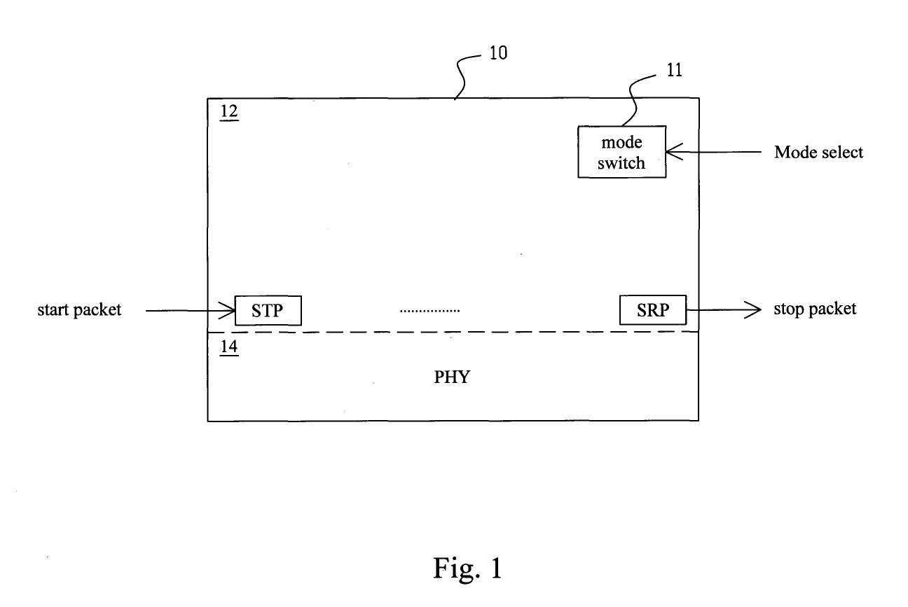

FIG. 1 is a simplified functional block diagram of an Ethernet switch chip according to the present invention. An Ethernet switch chip 10 comprises a digital part 12 and an Ethernet PHY 14. The switch chip 10 has several ports, and the PHY 14 includes the analog circuits of the transceivers for each of the ports. The chip 10 also has a mode switch 11 to receive a mode select signal from the external and thereby to switch between normal mode and test mode. Under the test mode, a STP and a SRP are selected among the ports of the chip 10, and a start packet is fed to the STP to be transmitted through each one of the ports in succession and to result in a stop packet at the SRP. In the packet delivery process, each port sends out the test packet from its transmitter, receives the transmitted test packet from its receiver after the test packet passed through the external, and then transmits the received test packet to the next port. This manner the test packet is delivered port by port until it reaches to the SRP. The chip 10 is then verified in accordance with the stop packet. For the test, the chip 10 only has to be added with a pin for the mode select signal to switch the chip 10 to the test mode. As far as the other pins used for the test, they are the original pins of each port. Particularly, in comparison with the conventional test scheme, the test pins for the respective tests of digital circuit and analog circuit can be all removed.

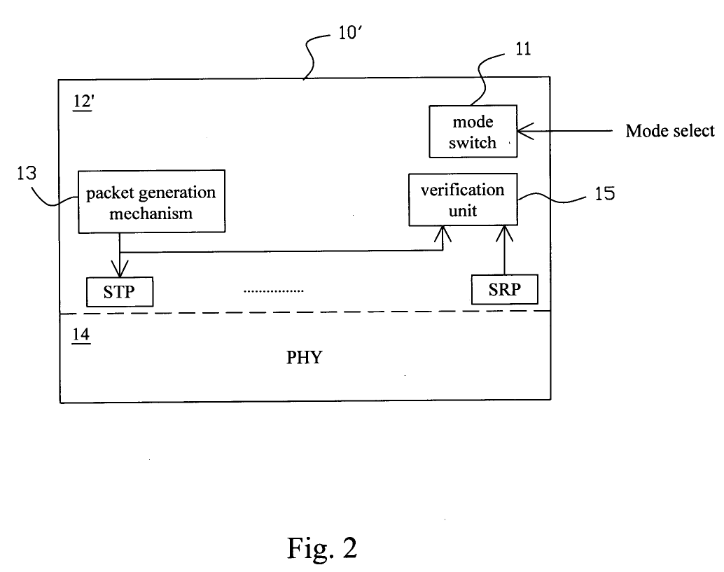

FIG. 2 is a simplified functional block diagram to illustrate another embodiment according to the present invention. An Ethernet switch chip 10′ comprises a digital part 12 and an Ethernet PHY 14. Likewise, the chip 10′ includes several ports and a mode switch 11, and selects a SRP and a STP from the ports under the test mode. Additionally, the chip 10′ comprises a packet generation mechanism 13 by which a start packet is generated for the STP. In the same manner, a stop packet is received at the SRP after the test packet is transmitted port by port. However, the chip 10′ further comprises a verification unit 15 to determine if the test result of the chip 10′ is correct by comparing the stop packet at the SRP with the start packet from the packet generation mechanism 13.

In the above embodiments, the mode switch 11, packet generation mechanism 13 and verification unit 15 can be implemented with either hardware or software, and the mode select signal can be inputted from an individual pin or a shared pin with other signals to reduce the pin counts.

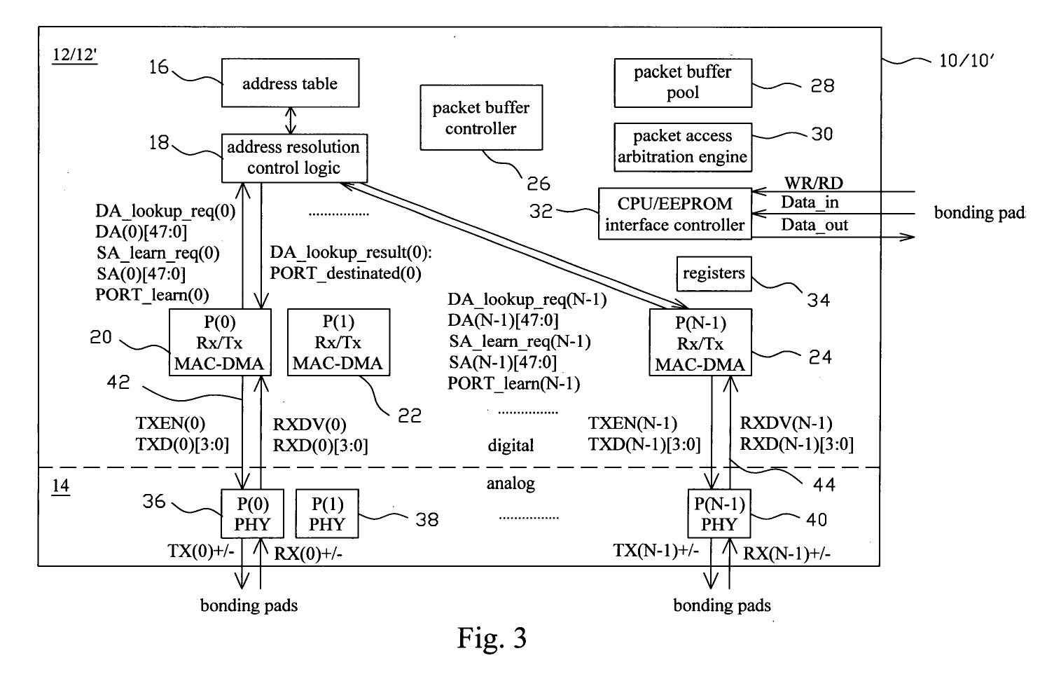

More detailed circuit for the chip 10/10′ is shown in FIG. 3. As in the conventional integrated Ethernet switch chip, the digital part 12/12′ comprises an address table 16, an address resolution control logic 18, medium access control-direct memory access (MAC-DMA) 20, 22 and 24 for several transceiver ports, a packet buffer controller 26, a packet buffer pool 28, a packet access arbitration engine 30, a CPU/EEPROM interface controller 32 and a register 34, and the analog part 14 comprises PHY 36, 38 and 40 for several ports corresponding to the MAC-DMA 20, 22 and 24, respectively. The signal connections between the chip 10/10′ and the external includes the write and read signal WR/RD, data input signal Data_in and data output signal Data_out for the CPU/EEPROM interface controller 32 connected to bonding pads, and the packet signals between the transmitters/receivers of those ports 36, 38 and 40 of the PHY 14 and bonding pads. In the illustrated chip 10/10′, the prominent difference between the daisy chain test and the conventional scheme includes the address resolution control logic 18, register 34, start packet signal 42 (TXEM (0) and TXD (0) [3:0]) and stop packet signal 44 (RXDV (N−1) and RXD (N−1) [3:0]). The address resolution control logic 18 includes destination address (DA) look-up and source address (SA) learning engine, which is equipped with the daisy chain test function and can carry out the daisy chain test under the test mode. The register 34 also stores all the required information for the test packet, including STP, SRP, daisy chain test control, packet length and quantity for self-test, packet patterns, normal and pause packets. The signal PORT_learn between the address resolution control logic 18 and each MAC-DMA indicates a packet incoming port and the source address to be learned, and the signal PORT_destined indicates the port where a packet should be sent out. There are three occasions, i.e., broadcasting to all ports other than the incoming port, filtering the ports that have the same destination port as the incoming port, and unicasting to the searched port.

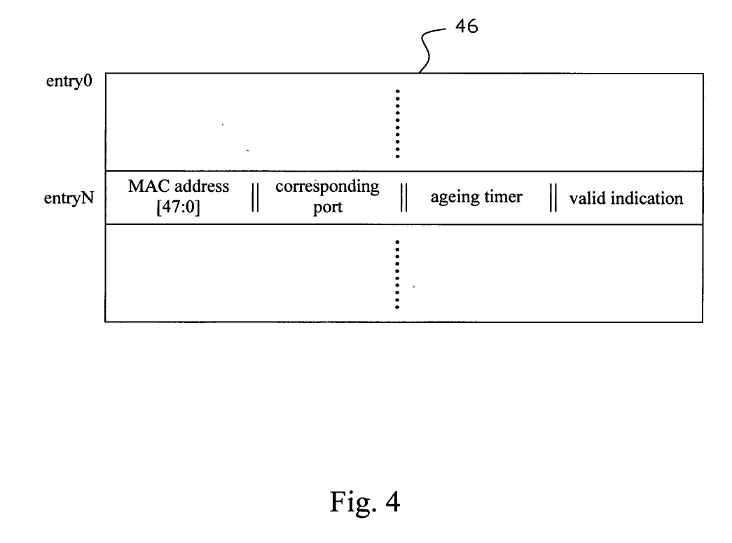

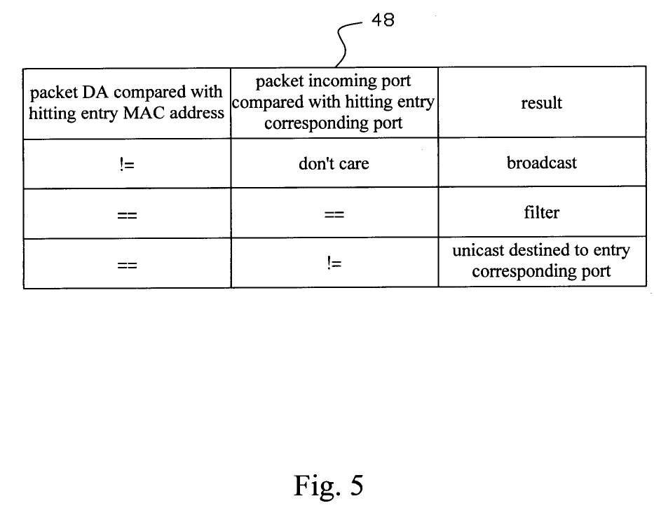

FIG. 4 illustrates an information format of an address table. An address table 46 includes several entries, each of them is given a sequence number. The content of each entry contains MAC address, corresponding port, ageing timer and valid indication. The content of the address table is provided for reference of the address resolution control logic 18. Normally the address resolution control logic 18 uses the function of DA search to look up the destination port of the packet. FIG. 5 shows the result of such destination search, including broadcasting, filtering and unicasting to entry-related ports. Fields 1 and 2 of table 48 indicates the conditions of the comparisons between packet DA and hitting entry MAC address and between packet incoming port and hitting entry corresponding port under different situations, respectively.

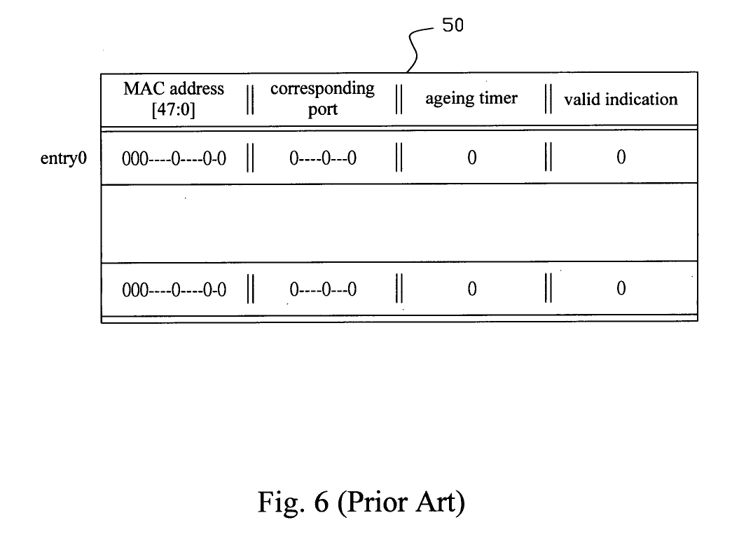

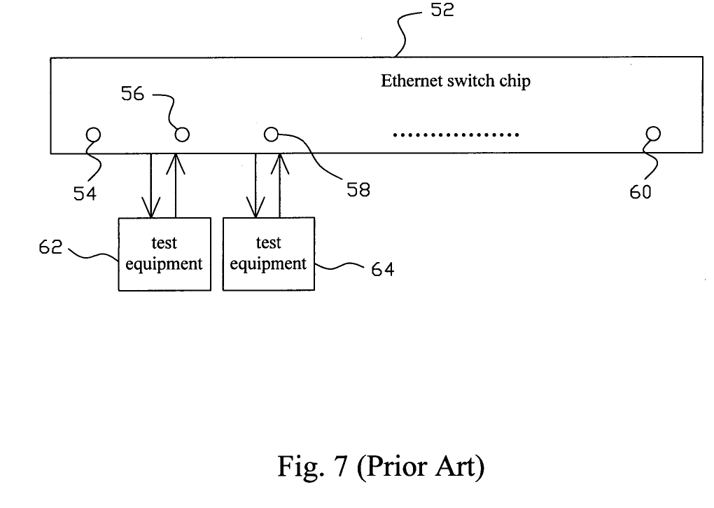

In the test of the Ethernet switch, the address resolution control logic 18 is used to operate its source address learning engine to perform a source address learning process to test the function of the Ethernet switch. For convenience of illustrating the principle and test process of the present invention, the normal address resolution control operation is explained in advance, which first initializes the address table 46, i.e., cleans the address table 46 or writes “0” into each of records of the address table 46, as shown in the content of address table 50 in FIG. 6. Next, when a packet is received, the SA of the packet is learned and the information of the port will be corresponded to the incoming port. FIG. 7 illustrates the arrangement of the conventional learning process, in which ports 54, 56, 58 to 60 of switch 52 are connected to test equipments, for example the ports 56 and 58 are connected to test equipments 62 and 64, respectively. In the learning process:

| | | |
|---|---|---|
| Packet of port 56: | DA | 00 00 00 00 00 02, |
| | SA | 00 00 00 00 00 01; |
| Packet of port 58: | DA | 00 00 00 00 00 01, |
| | SA | 00 00 00 00 00 02. |

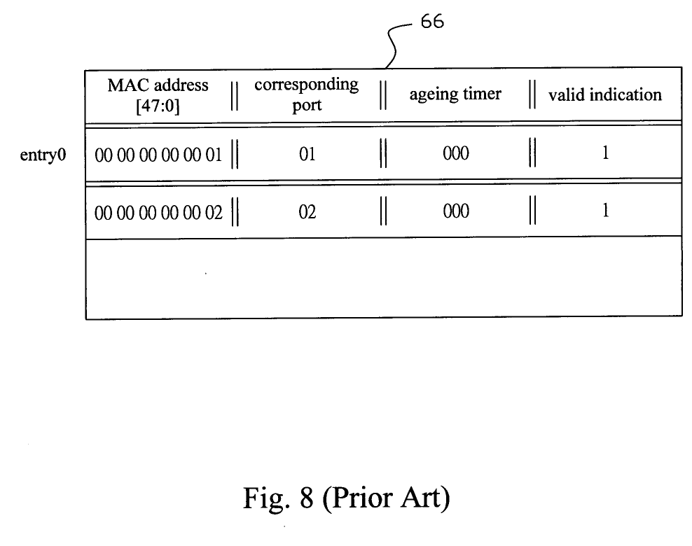

The learned result is shown in address table 66 in FIG. 8, and the DA search result is

| Packet of port 56: | DA | 00 00 00 00 00 02, |
|---|---|---|
| | SA | 00 00 00 00 00 01, |
| | directed to the second paort; | |
| Packet of port 58: | DA | 00 00 00 00 00 01, |
| | SA | 00 00 00 00 00 02, |

directed to the first port.

From FIG. 7, the conventional chip does not provide digital pins to undertake the test but requires expensive and complicated tester. Moreover, the register inside the chip does not have any information regarding to test packet.

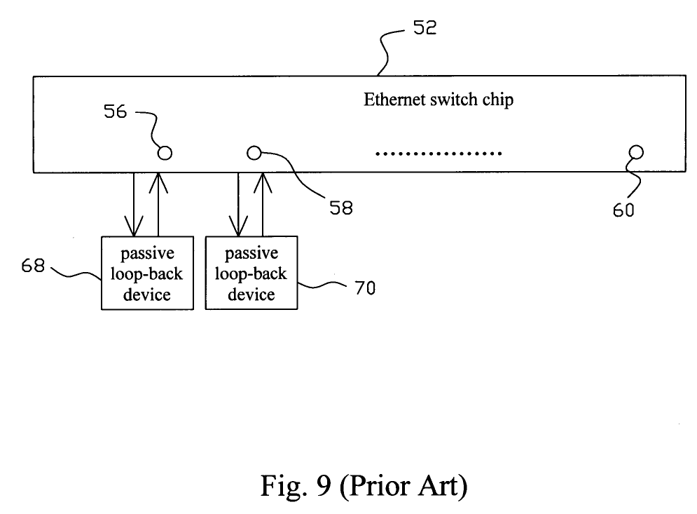

If the arrangement in FIG. 7 is modified with replacement of passive loop-back devices, as shown in FIG. 9, for example the ports 56 and 58 are connected to passive loop-back devices 68 and 70, respectively. A packet flow with a series of addresses that are increased progressively in succession at the port 56 is

| | | |
|---|---|---|
| First packet: | DA | 00 00 00 00 00 02, |
| | SA | 00 00 00 00 00 00 01; |
| Second packet: | DA | 00 00 00 00 00 03, |
| | SA | 00 00 00 00 00 02; |
| Third packet: | DA | 00 00 00 00 00 04, |
| | SA | 00 00 00 00 00 03; |

......; and so forth.

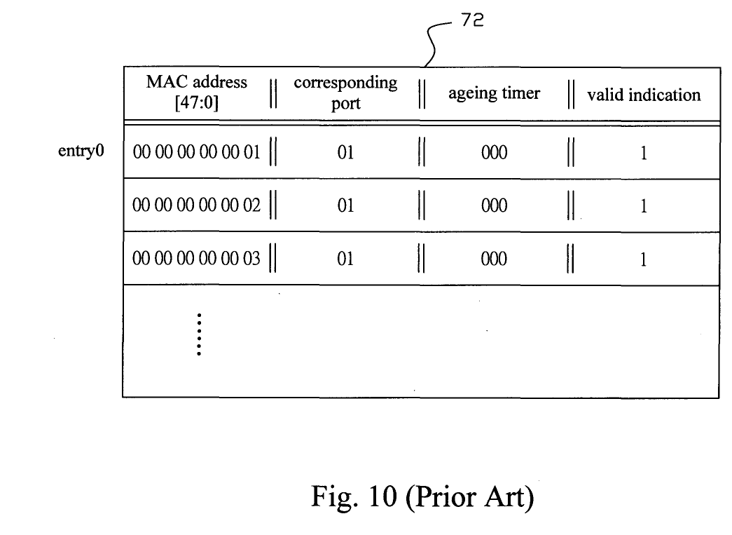

As the initial values of the address table is cleaned to 0, as shown in table 50, the packet returned by the passive loop-back device 68 can not find its destination port and thus, they are all broadcasted to other ports. The learned result of the packet flow returned by the passive loop-back device 68 is shown in table 72 in FIG. 10. However, the packet transmitted by other ports passing through its corresponding passive loop-back device, via the result of search address table 72, will be sent out from the port 56 and again returned through the passive loop-back 68. The SA of the packet flow returned from other ports will be once again learned so that the dynamic change of the address table becomes unpredictable. Besides, the packet flow transmitted to other ports is being returned consistently to its own port, and thus the system will be completely collapsed.

In general, an Ethernet switch is necessary to be verified to the terms including

(1) Full line speed: the transforming port can transmit 148,810 packets/sec for 100M and 14,880 packets/sec for 10M.

(2) Packet pattern: including unicast, broadcast, filter and pause packets. The DA of the pause packet is set as 01 80 c2 00 00 01. Whenever a port receives the pause packet, the port should stop sending out packets until a timer slot expires.

(3) Port duplex: including full-duplex and half-duplex.

These terms can be tested by the daisy chain test of the present invention.

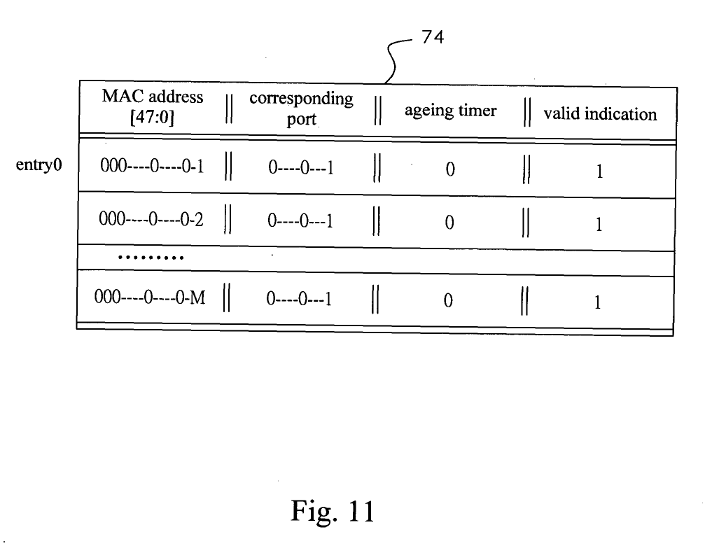

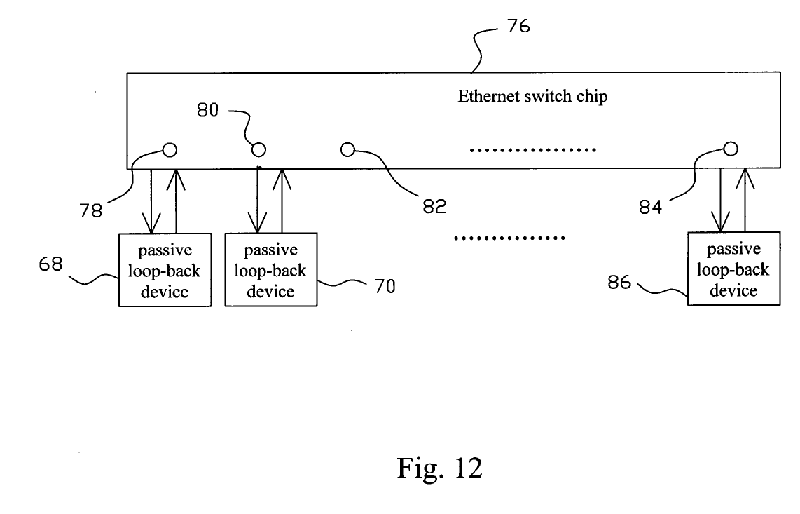

In the operation of the address resolution control of the present invention, it includes an initialization of address table for daisy chain test, i.e., writing the testee MAC address and adding 1 to the sequence number of the STP for all entries (or addresses), and when a packet is received, the SA of the packet is learned and the information of the port will be programmed as the sequence number of the original entry port plus 1, unless the port sequence number shows a SRP and it is not altered. In particular, the address table is cleaned and the STP is set to port 0 first, as shown in the content of address table 74 in FIG. 11. The arrangement for learning process is shown in FIG. 12, in which switch 76 includes ports 78, 80, 82 and 84 connected to passive loop-back devices 68, 70 and 86, respectively. The packet flow with addresses that are increased progressively in succession at the port 78 is

| | | |
|---|---|---|
| First packet: | DA | 00 00 00 00 00 02, |
| | SA | 00 00 00 00 00 01; |
| Second packet: | DA | 00 00 00 00 00 03, |
| | SA | 00 00 00 00 00 02; |
| Third packet: | DA | 00 00 00 00 00 04, |
| | SA | 00 00 00 00 00 03; |
| Fourth packet: | DA | 00 00 00 00 00 05, |
| | SA | 00 00 00 00 00 04; |
| Fifth packet: | DA | 00 00 00 00 00 06, |
| | SA | 00 00 00 00 00 05; |

......; and so forth.

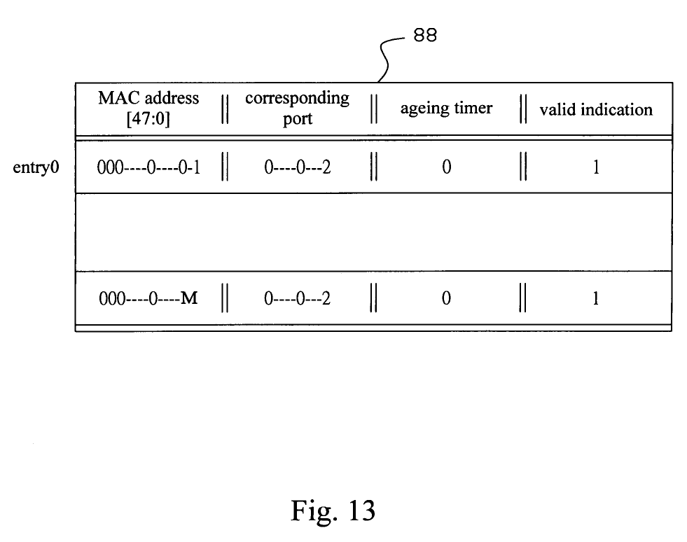

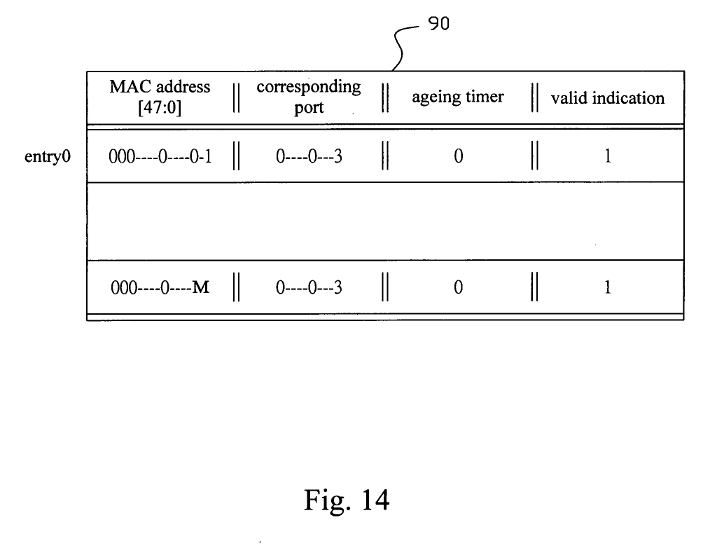

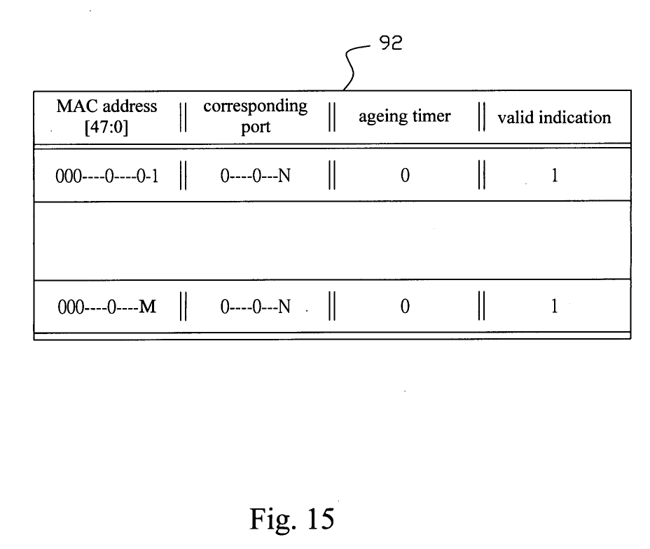

The learned result after the packet flow returned through the port 68 is shown in address table 88 in FIG. 13. All the packets will be transmitted to the next port 80 to be sent out, passing through the passive loop-back device 70 and returned to the port 80, and the result of DA search address table 88 is transmitted to the next port 82 with the learned result of returning to the port 80 as shown in address table 90 in FIG. 14. After sent out and returning to the port 82, the result of the DA search address table 90 will be transmitted to the next port and so on, until the port before port 84, by which the learned result after returning is shown in address table 92 in FIG. 15. After sent out from and returning to the port 84, the source port learning will not be added by 1 and the DA search result will not be transmitted to the next port but is filtered, for the port 84 is the SRP. Then the test result is obtained by verifying the final test packet at the SRP. The embodiment chip provides a digital pin for the daisy chain test. Instead, if it is not desired the additional digital pin, a counter can be provided in the chip to count the cyclic redundancy check (CRC) of the packets and the quantity of lost packets.

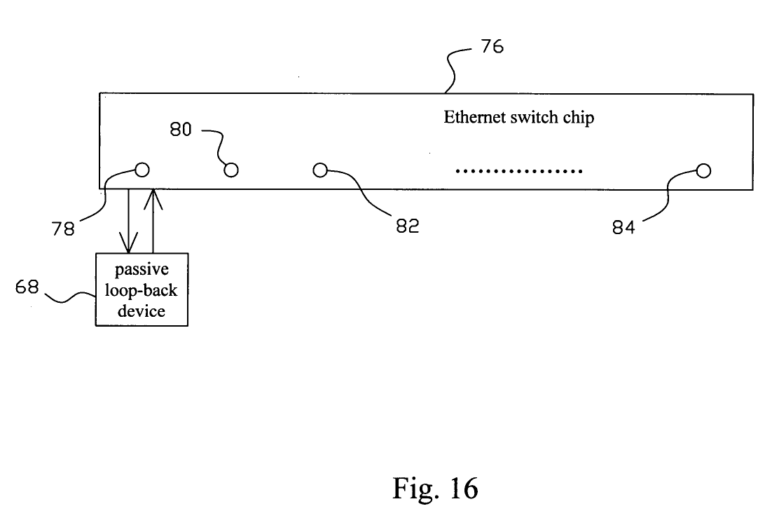

For the broadcasted packets, the foregoing test principle is still applicable, only that a minor modification is needed for the test arrangement, as shown in FIG. 16. Only one of the ports 78, 80, 82, . . . , 84 is selected to be connected to passive loop-back device 68, and the rest will not.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claim d is:

1. A single chip Ethernet switch comprising:
a physical layer entity (PHY) including a plurality of ports;
an address table for being written to and read out information to operate the plurality of ports;
a switch for switching the Ethernet switch to a daisy chain test mode; and
an address resolution control logic including a test engine for performing a packet source address learning process under the daisy chain test mode to deliver a test packet through the plurality of ports progressively.

2. The switch of claim 1, further comprising an input for receiving the test packet.

3. The switch of claim 1, further comprising a packet generator for generating the test packet.

4. The switch of claim 3, further comprising a register for storing information of the test packet.

5. The switch of claim 1, further comprising a verification unit for verifying the test packet.

6. The switch of claim 1, further comprising an output for sending out the test packet.

7. The switch of claim 1, wherein the test engine includes a writing apparatus for writing a set of initial addresses to the address table under the daisy chain test mode.

8. The switch of claim 1, wherein the packet source address learning process sets a packet destination address as a next port.

9. A daisy chain test for a single chip Ethernet switch integrated with a physical layer entity including a plurality of ports, the switch having an address table for being written to and read out information to operate the plurality of ports, the test comprising the steps of:
connecting each of the plurality of ports to a respective passive loop-back device;
selecting a start transmission port and a stop receiving port from the plurality of ports;
supplying a test packet to the start transmission port; and
proceeding a packet source address learning process for delivering the test packet from the start transmission port to the stop receiving port progressively.

10. The test of claim 9, further comprising inputting the test packet to the switch.

11. The test of claim 9, further comprising generating the test packet in the switch.

12. The test of claim 9, further comprising verifying the test packet after the stop receiving port.

13. The test of claim 12, further comprising sending out the test packet from the stop receiving port.

14. The test of claim 9, wherein the learning process sets a packet destination address as a next port.
